(19) United States
(12) Patent Application Publication
(10) Pub. No.: US 2016/0081280 A1
(43) Pub. Date: Mar. 24, 2016

(54) MODULAR TRAY GREEN ROOF SYSTEM AND METHOD

(71) Applicant: Intellectual Property Holdings, LLC, Cleveland, OH (US)

(72) Inventors: Dan T. Moore, Cleveland Heights, OH (US); Patrick J. Hoffman, Wooster, OH (US)

(21) Appl. No.: 14/860,311

(22) Filed: Sep. 21, 2015

Related U.S. Application Data
(60) Provisional application No. 62/052,660, filed on Sep. 19, 2014.
(60) Provisional application No. 62/102,767, filed on Jan. 13, 2015.

(51) Int. Cl. A01G 9/02; B29C 65/02

(52) U.S. Cl. CPC A01G 9/021; A01G 9/028; B29C 65/02; B29K 2067/003

(57) ABSTRACT

An exemplary tray for a module of a green roof system includes a bottom surface and a sidewall extending upward from the perimeter of the bottom surface to a lip. The tray may be formed of thermoplastic fiber. The bottom surface has one or more raised portions that divide the bottom surface into a plurality of cells. The raised portions form water drainage channels. At least the bottom surface of the tray has a porosity of about 50 percent to about 80 percent.

### RELATED APPLICATIONS

The non-provisional application claims priority to and the benefit of U.S. Provisional Patent Application No. 62/052,660, filed on Sep. 19, 2014, and entitled “Modular Green Roof Tray System”, and U.S. Provisional Patent Application No. 62/102,767, filed on Jan. 13, 2015, and entitled “Modular Green Roof Tray System”, both of which are incorporated herein by reference in their entirety.

### TECHNICAL FIELD

The present application relates generally to green roof systems, and more specifically to modular green roof systems.

### BACKGROUND OF THE DISCLOSURE

Buildings take up space, often replacing permeable surfaces and species rich green spaces with impermeable hard surfaces lacking vegetation. These hard surfaces change the landscape of a region and can have a negative environmental impact on both industrial and residential areas.

Green roof systems allow plants to be planted on the roof of a building or other structure where plant life would not naturally take root. Green roof systems provide many benefits. For example, a green roof system shields a building from the sun and provides an added layer of insulation so that the energy required to heat or cool the building is reduced, resulting in lower utility bills. Storm water is absorbed by plants growing in a green roof so that less water flows into the local sewer system. Plants also filter heavy metals and other particulate and pollution out of the water and air, creating a cleaner environment. Green roof systems can double the useful life of the roof of a structure. Additionally, green roof systems provide a habitat for local wildlife, add to wildlife corridors, generate social pride, promote aesthetic beauty, and create a peaceful workspace. Green roof systems not only promote the health of the natural environment, but are a valuable asset.

There are generally two types of green roof systems: extensive and intensive. Extensive roof systems have soil that is generally about 3 to 6 inches deep, are lightweight, and are typically limited in the species of plants that they can support. Extensive roof systems are often a low maintenance green roof solution, having low nutrient and irrigation requirements. Intensive roof systems have soil that is generally at least 6 inches deep and are heavier than extensive systems and can accommodate larger plants, such as trees and shrubs. Intensive roof systems typically require fertilization, irrigation, and regular maintenance.

### SUMMARY

Exemplary embodiments of green roof systems, modules, trays and methods of manufacturing the same are disclosed herein.

In certain embodiments, the module for a green roof system includes a tray, growing media, a plurality of seeds, a seed retaining mesh, and a top cover. The tray has a bottom surface, a sidewall extending upward from the perimeter of the bottom surface to a lip, and one or more raised portions separating the bottom surface into a plurality of cells. The tray is porous, allowing water to pass through while not permitting particles larger than about 10 microns in diameter to pass through. The top cover is heat bonded to the lip of the tray. PET plastic fibers sourced from recycled material may be used to make the tray, seed retaining mesh, and top cover. The tray may also be thermoformed from a blanket of non-woven PET plastic fibers. The growing media includes at least one of expanded shale, clay, and slate; sand; wood fines and/or coir; and compost and/or biosolids. The seeds and growing media may be selected based on the climate of the geographical region where the module is installed.

An exemplary tray for a module of a green roof system includes a bottom surface and a sidewall extending upward from the perimeter of the bottom surface to a lip. The bottom surface has one or more raised portions that divide the bottom surface into a plurality of cells. The raised portions form water drainage channels. At least the bottom surface of the tray has a porosity of about 50 percent to about 80 percent.

Another exemplary embodiment of the present application relates to a method of making a tray for a module of a green roof system. The method includes providing a plurality of plastic fibers; forming a non-woven blanket from the plastic fibers; cutting the non-woven blanket to a desired size; and forming the non-woven blanket into a tray. The tray has a bottom surface and a sidewall extending upward from the perimeter of the bottom surface to a lip. One or more raised portions of the bottom surface divide the bottom surface into a plurality of cells.

An exemplary green roof system includes a plurality of modules. Each module includes a tray for containing growing media; a plurality of seeds; a seed retaining mesh; and a top cover. The plurality of modules are arranged on a rooftop. Water drainage channels are formed between the tray and the rooftop.

### BRIEF DESCRIPTION OF THE DRAWINGS

These and other features and advantages of the present application will become better understood with regard to the following description and accompanying drawings in which:

FIG. 1A is a top perspective view of a module of a green roof system according to an embodiment of the present application, before any plants have grown;

FIG. 1B is a bottom perspective view of the module of FIG. 1A;

FIG. 1C is a cross-section of the module of FIG. 1A along the line 1C:1C;

FIG. 1D is an enlarged view of the cross-section of FIG. 1C in the area 1D;

FIG. 2A is a perspective view of a module of a green roof system according to an embodiment of the present application, with plants growing through the cover 220;

FIG. 2B is a cross-section of the module of FIG. 2A along the line 2B:2B;

FIG. 3 is a perspective view of a green roof system according to an embodiment of the present application installed on a rooftop;

FIG. 4 is a flow chart describing the steps of an exemplary method of manufacturing a tray for a module of a green roof system; and

FIG. 5 is a flow chart describing the steps of an exemplary method of manufacturing a module of a green roof system.

### DETAILED DESCRIPTION

Conventional modular roof systems generally include rigid containers or pans placed on top of a multi-layer underlayment. The rigid containers are commonly made from hard plastic. For example, U.S. Pat. No. 6,862,842 discloses a green roof pan that is 2 feet wide by 4 feet long and has a height of 1.5 to 8 inches. The pan may be vacuum formed or molded from high density polyester, polyethylene, or a mixture of the two. The pan may also include drainage holes to allow water to drain out of the pan. The multi-layer underlayment generally protects the existing roof from the modular roof system and may include, for example, a root barrier, a protection mat, a drainage mat, a filter sheet, or the like.

The components of a conventional modular roof system are generally delivered separately and assembled on the roof. The separate delivery of the components incurs various delivery fees and requires storage of the components before they are assembled and installed. Further, because of the complexity of the installation, most modular green roof systems are installed by a contractor. For example, before installation of the modular green roof system, a water drainage system may need to be installed. The trays may then be arranged on an underlayment, filled with growing media, and then plugs or mats of pre-grown vegetation are planted in the assembled trays.

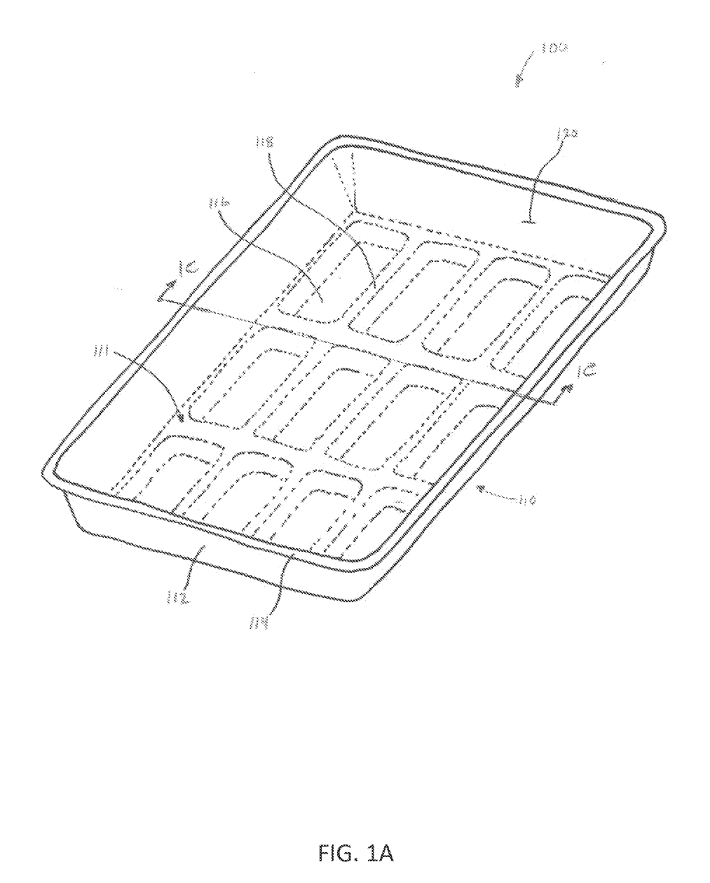

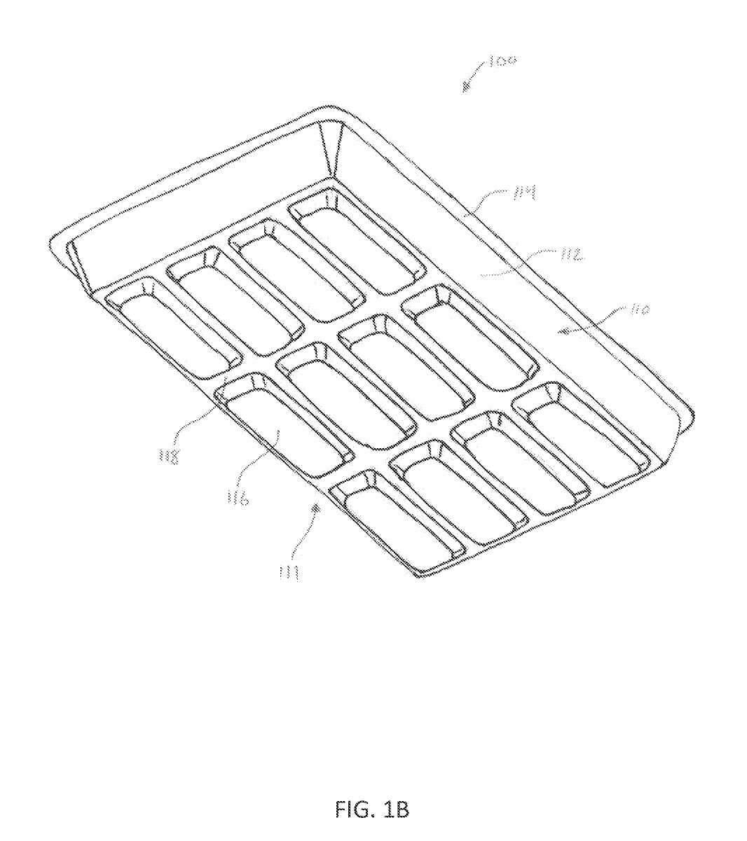

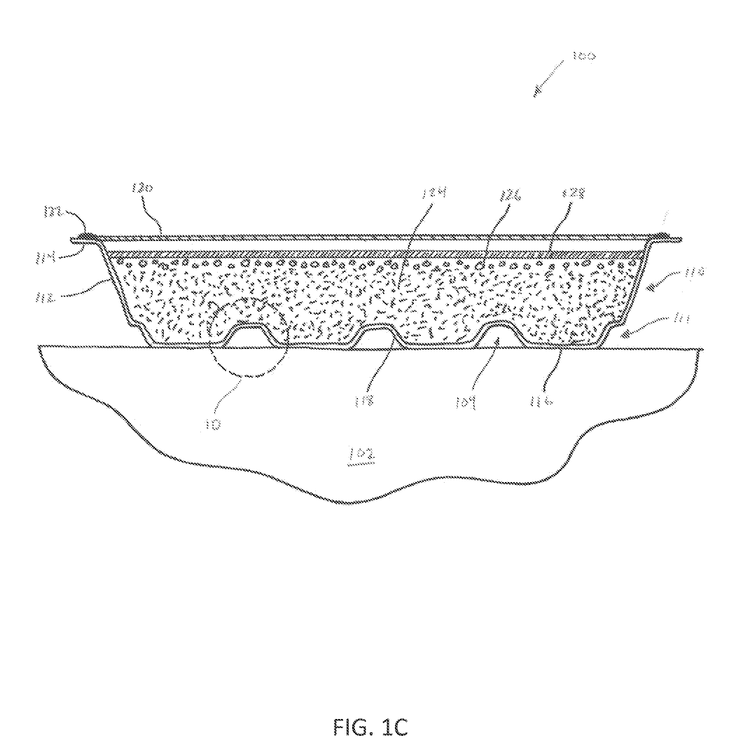

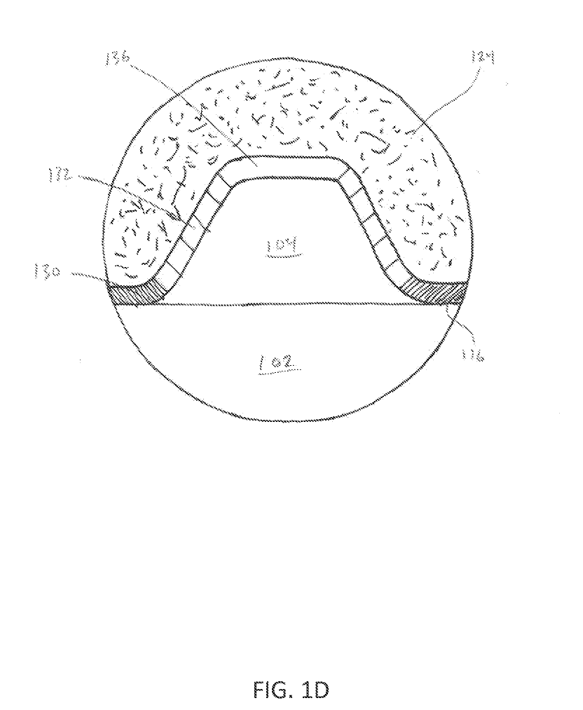

Referring now to FIGS. 1A, 1B, 1C, and 1D, an exemplary green roof module 100 of the present application is shown. The module 100 includes a tray 110 that is generally rectangular in shape (when viewed from above), but can be any shape, such as, for example, a square, a pentagon, a hexagon, an octagon, or any other shape that provides sufficient coverage of a rooftop when multiple modules 100 are arranged together. The tray 110 has a bottom surface 111 and side walls 112 that extend upward from the bottom surface 111 to a lip 114.

The bottom surface 111 is formed into a plurality of cells 116 separated by raised portions 118. The cells 116 serve as feet that contact the roof surface 102 to support the module 100 and keep it from moving around. The tray 110 shown in FIG. 1A has a twelve-cell structure, however, the tray 110 may have any number of cells 116.

In conventional modular green roof systems, water draining through drainage holes in the tray often carries growing media away from the tray. Loss of growing media can harm plants growing in the trays. The lost media can also collect on the roof, clogging downspouts and roof drains. Often, conventional roof systems have a plastic filter mat and hard plastic drainage layer underneath the trays to capture lost growing media to prevent damage to the roof drainage systems and roof structure.

The module 100 of the present application addresses this issue found in conventional modular green roof systems. For example, the tray 110 of the module 100, or a portion thereof, of the present application is made of a material that permits water to pass through the tray while prohibiting growing media from escaping through the tray. In certain embodiments, the material prohibits growing media particles having an average diameter as small as 0.01 mm from escaping through the tray. In other embodiments, the minimum sized particle that is prohibited from escaping through the tray material has an average diameter between about 0.02 and 9.5 mm. Because the thermoformed tray allows drainage and prevents loss of growing media, a drainage mat and a hard plastic drainage layer are not needed as in conventional roof systems.

At least a portion of the bottom surface 111 of the tray 110 may be porous such that a water drainage system is incorporated into the tray 110. For example, water drainage channels 104 may be formed by the roof surface 102 and raised portions 118. The raised portions 118 are formed in multiple directions along the bottom surface 111 of the tray 110. In certain embodiments where the entire bottom surface 111 of the tray 110 is water permeable, a larger amount of water flows through the bottom surface 111 in the area of the channels 118 as they are not obstructed by the roof surface 102 (see FIG. 1C) and provide the least resistance to the flow of the water. Thus, this drainage system prevents loss of growing media while also reducing installation time over roof systems requiring an underlayment.

The tray 110 may be modified to protect the plants from drought conditions or insufficient watering. During drought conditions, retention of water is often important for plant survival. For example, one or more portions of the tray 110 may be made impermeable to water. This may include, for example, one or more sections of the bottom surface 111, the side walls 112, or the cells 116. In some embodiments, for example, a water impermeable layer is added to the interior and/or exterior of the tray 110 on the bottoms 130 and/or sides 132 of the cells 116 to prohibit water from draining out of the cells 116. Alternatively, the bottoms 130 and/or sides 132 of the cells 116 may be subjected to increased heat and/or pressure relative to the rest of the bottom surface 111 when the tray 110 is formed, thereby creating impermeable portions of the tray 110 or portions of the tray 110 having decreased permeability. In some other embodiments, the bottoms 130 of the cells 116 are impermeable and the sides 132 have a low permeability so that some water still passes through, but at a slower rate than the tops 134 of the raised portions 118.

In these embodiments, when the cells 116 fill with water, the water drains out through the tops 134 of the raised portions 118. With the bottom surface of the cells being impermeable to water, water draining channels 104 formed by the roof surface 102, sides 132, and the raised portion 118 carry water out of the tray with a slower rate of drainage. The increased retention of water in the tray due to the impermeability of portions of the tray provides increased moisture to the plants over time. Also, the height of the raised portions 118 may be selected to permit more or less water to be retained within the cells 116.

The tray 110 of the module 100 may be made of a porous, non-woven material that allows water to pass through the bottom surface 111 of the tray 110 while prohibiting growing media 124 from escaping through the tray 110. In certain embodiments, the porous non-woven material used to form the tray 110 is formed of a plurality of fibers. The fibers are not woven together, but are bonded together chemically (e.g., by applying an adhesive or binder), mechanically (e.g., by entangling the fibers), thermally (e.g., by melting portions of the fibers together), or by some combination of the same. The fibers may be the same size or may be a blend of sizes. The size of the space between the fibers determines the size of the particles that it can prohibit from passing through, while still being large enough to allow water to pass. In certain embodiments, gaps between the fibers are about 0.01 mm to about 0.04 mm, or about 0.015 mm to about 0.030 mm, or about 0.02 mm. The percentage of empty space between fibers in a given volume of the non-woven material also determines the porosity of the material. In certain embodiments, the non-woven material of the tray 110 has a porosity ranging from about 50 to 80 percent, or about 65 to 75 percent, or about 70 percent.

The tray 110 may also be thermoformed from a blanket of non-woven polyester fibers and/or polypropylene fibers. One polyester fiber that may be used is polyethylene terephthalate (PET) which is a semi-aromatic copolymer resulting from the polycondensation of terephthalic acid with ethylene glycol. In some embodiments, the tray 110 is made from a non-woven blanket of entirely PET fibers. The PET fibers may have a length of about 30 to 100 millimeters, or about 50 to 80 millimeters, or about 65 millimeters. The PET blanket is generally thermoformed at about 204-210 degrees Celsius (about 400-410 degrees Fahrenheit). While the plastic fibers described above are formed of PET, a variety of other materials may be used, such as a non-woven bi-component fibers made from nylon and polyester, or the like.

The PET fibers may also be formed entirely from post-consumer recycled PET fiber, thus no virgin PET fiber is used to make the tray 110. Post-consumer PET fiber is generally made from material or finished product that has served its intended use and has been diverted from being disposed or recovered from already disposed waste products. In some embodiments, the PET for the fibers used to make the tray 110 comes from beverage bottles that are melted and spun into fibers of various sizes, or deniers (grams per 9000 meters). The fibers are formed into a non-woven fiber blanket that is cut to size and thermoformed into a tray, such as the tray 110 shown in FIG. 1A.

In certain embodiments, the size of fibers used to make the non-woven material of the tray (e.g., a PET blanket) may range from about 2.5 denier to about 13 denier. Different size fibers give the tray 110 different properties. For example, larger fibers impart more strength and rigidity to the tray 110. Smaller fibers melt more quickly than larger fibers, thereby forming connections between the different size fibers. Smaller fibers also fill in the empty spaces in the tray, serving as a filter that allows water to pass through the tray while prohibiting particles from passing through. A tray 110 incorporating a variety different size fibers may benefit from the desirable qualities provided by fibers of each size.

In certain embodiments, at least three different size fibers are used to make the non-woven material (e.g., a PET blanket) of the tray 110. For example, a first fiber size may be about 2.5 to 4 denier, a second fiber size may be about 5 to 8 denier, and a third fiber size may be about 9 to about 13 denier. In another example, fibers may be about 2.5 denier, about 6 denier, and about 9 denier. These various sizes permit the entire tray, not just the bottom surface, to be porous. The various sized fibers may also be used in various quantities to form the tray. In some embodiments, each size fiber makes up about one third of the tray. In other words, about 33% of fibers are a first size, about 33% of the fibers are a second size, and about 33% of the fibers are a third size.

In one embodiment, the tray 110 is made from a non-woven blanket of PET fibers that are formed entirely from post-consumer PET fiber. The material includes three different sizes of PET fibers that are about 2.5 denier, about 6 denier, and about 9 denier. The PET fibers may also be formed entirely from post-consumer recycled PET fiber. The material of the tray 110 has a porosity ranging from about 50 to 80 percent. The tray 110 allows water to pass through and prohibits growing media particles as small as 0.01 mm from passing through.

As shown in FIG. 1C, the tray 110 is filled with growing media 124 which is compacted to a desired height (e.g., about 2½ to about 3¼ inches). The growing media 124 provides the organic matter for sustained ecological growth of the plants. The nutrient and mineral base of the growing media 124 may be sufficient for the initial plant life cycle so that little or no additional supplements are required. The mixture is designed for fast draining, high water retention, and low compression. In certain embodiments, the mixture is capable of retaining about 6 to 8 pounds of water per square foot, or about 7 pounds of water per square foot when the tray is sitting on a substantially flat surface. In certain embodiments, excess water drains through the mixture at a rate of up to about 10 gallons per minute per tray, or about 5 to 8 gallons per minute per tray. In certain embodiments, the drainage flow rate may change depending on the pitch of the roof used to support the modules.

In certain embodiments, the growing media 124 is made from a mixture of expanded Haydite, clay aggregates, sand, and organic material. In some embodiments, the growing media 124 may include about 80% Haydite, about 10% organic yard compost, about 5% wood fines (a mulch byproduct) and/or coir (a fibrous product from coconut husks), and about 5% rich compost and/or biosolids. The location, height, solar exposure, and frequency of precipitation events are factors that affect the nutrient base of the growing media 124 over time. In some embodiments, the growing media 124 is customized for the geographic area in which the green roof system will be installed so that it better supports plant growth through all seasons expected in that geographic area.

Seeds 126 are sown in the growing media 124 with a spacing and depth appropriate for the type of seeds 126 being planted. The type of seeds 126 planted include seeds for a variety of plants that are hardy and long-living. For example, seeds 126 are selected for their perennial growth cycle and for their resistance to drought. Like the growing media 124, the mixture of seed types can be customized for the geographic area in which the green roof system will be installed.

A seed retaining mesh 128 is placed on top of the seeded growing media 124 to prevent seeds 126 from falling out of the module 100 during packaging, shipment, and installation. The seed retaining mesh 128 entangles seeds 126 in its mesh during the transport and installation of the module 100. In certain embodiments, the seed retaining mesh 128 is a non-woven layer formed of PET (e.g., the post-consumer PET disclosed herein) that is spread evenly over the surface of the growing media 124 in the tray 110. Spaces between the fibers of the seed retaining mesh 128 allow the growing media 124 below to be seen. However, the seed retaining mesh 128 holds back fine particles of the growing media 124 (e.g., particles not less than about 0.01 mm in diameter) that are dislodged from the tray during transport, installation, or heavy rainfall. The seed retaining mesh 128 also retains moisture on the surface of the growing media 124 by trapping water droplets between the fibers of the mesh, providing extended moisture exposure for the seeds after rainfall or watering.

A cover 120 is placed on top of the module 100. The cover may be heat bonded to the lip 114 of the tray 110 at a cover joint 122. The cover 120 is heat bonded to the tray lip 114 at about 149-160 degrees Celsius (about 300-320 degrees Fahrenheit) by any suitable means (e.g., with a heat gun, a heated tool, or the like). The cover 120 is porous and may be formed from a non-woven PET blanket (e.g., the post-consumer PET blanket disclosed herein). In some embodiments, the cover 120 is a green-colored Nylon netting provided by Bonar Corporation with a varying cell structure between ⅛ inches and ¼ inches.

The addition of the cover 120 to the tray 110 completes the green roof system module 100. The growing media 124 and seeds 126 are trapped within the tray 110 by the seed retaining mesh 128 so that movement of the module 100 does not disrupt the growing media 124 and seeds 126. In some embodiments, the module 100 can be turned upside down without disruption to functioning of the tray 110.

The growing media 124 is generally the heaviest component of the module 100. In some embodiments in which the tray is approximately 25 inches long, 13 inches wide, and 4 inches high, the growing media 124 weighs about 26 lbs and the combined weight of the tray 110, seeds 126, seed retaining mesh 128, and top cover 120 is about 1 pound. Thus, the total weight of the dry module 100 is about 27 lbs, which is light enough to be carried to a rooftop without using lifting equipment. After saturation with water, the module 100 weighs about 39-45 lbs. Thus, the areal density of the module 100 is about 12 lbs/sq ft when dry and about 17-20 lbs/sq ft when wet. It should be understood that the trays of the present application may be a variety of sizes.

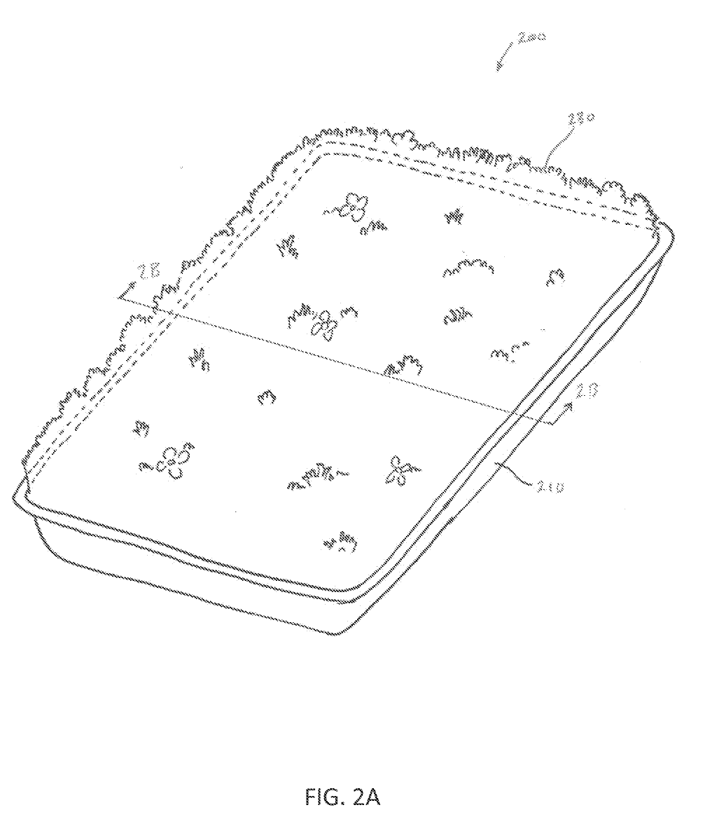

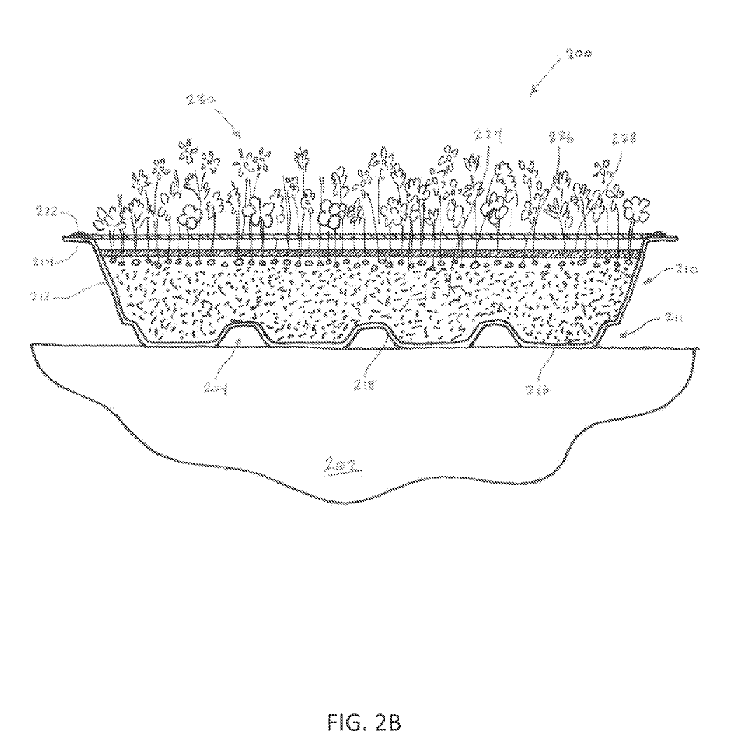

Referring now to FIGS. 2A and 2B, an exemplary green roof module 200 is shown. The module 200 is similar to the module 100 described above, except that plants 230 have grown to cover the top of the module 200. The tray 210 has a bottom surface 211 and side walls 212 that extend upward from the perimeter of the bottom surface 211 to a lip 214. The bottom surface 211 is formed into a plurality of cells 216 separated by raised portions 218. The cells 216 serve as feet that contact the roof surface 202 to support the module 200 and keep it from moving around. Water drainage channels 204 are formed by the roof surface 202 and raised portions 218 between the cells 216.

The tray 210 is filled with growing media 224. The growing media 224 is compacted to a desired height after being deposited in the tray 210. Seeds 226 are sown in the growing media 224 with a spacing and depth appropriate for the type seeds 226 being planted. A seed retaining mesh 228 is laid on top of the seeded growing media 224 to prevent seeds 226 from falling out of the module 200 during packaging, shipment, and installation. A cover 220 is laid on top of the entire module 200 and then heat bonded to the perimeter lip 214 of the tray 210.

The seeds 226 of module 200 have germinated and sprouted. The plants 230 growing from the seeds 226 extend through the seed retaining 228 and top cover 220 layers. The seed retaining 228 and top cover 220 layers provide lateral support for taller plants 230 growing in the module 200. Plants with a pointed sprout may be selected so that they more easily push through the seed retaining mesh 228 and cover 220 during early growth. The cover 220 continues to retain the growing media 224 and seeds 226 inside the tray 210 after the plants 230 have grown. In some embodiments, the plants 230 grow to cover at least 90% of the surface of the module 200. In some embodiments, the amount of foliage from mature plants 230 hides the top cover 220 from sight.

In certain embodiments, the tray 210, seed retaining mesh 228, and top cover 220 are made from the same non-woven PET fiber blanket disclosed herein. For example, all these components may be formed from a PET blanket having various fiber sizes, e.g., at least three different fiber sizes, and/or be made from post-consumer PET.

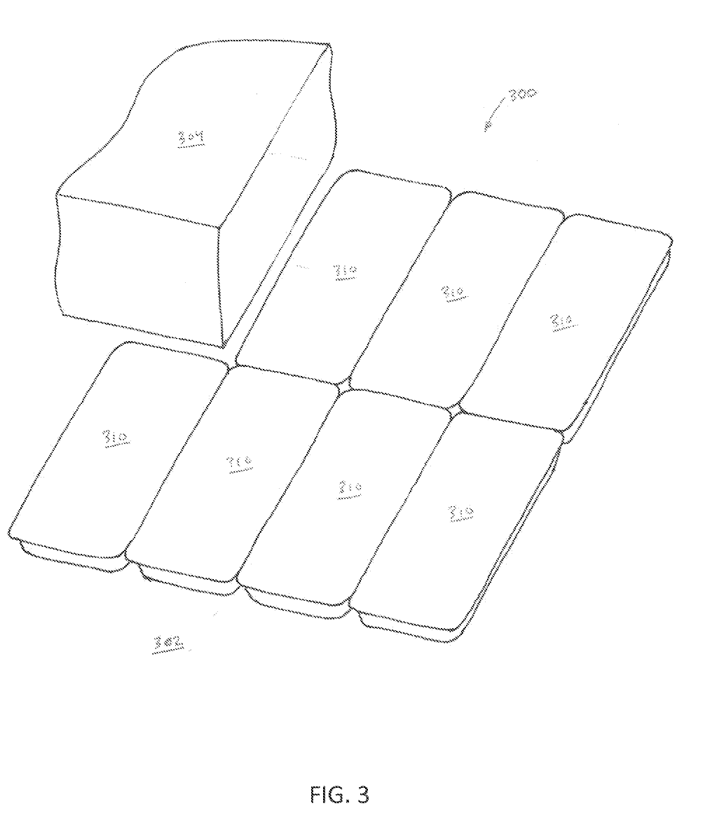

Referring now to FIG. 3, an installed green roof system 300 is shown. A plurality of modules 310 are arranged on the roof top 302, avoiding various obstacles 304 that project from the roof top 302. The modules 310 can be any of the modules described herein.

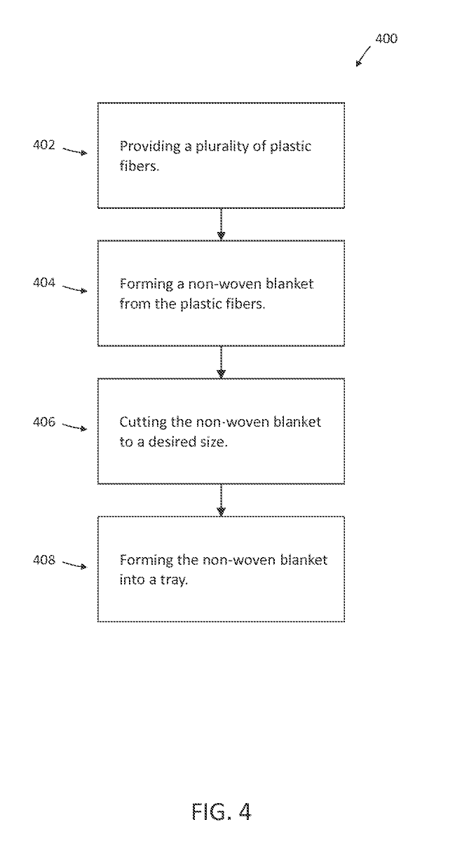

Referring now to FIG. 4, a flow chart of an exemplary method 400 of manufacturing a tray for a module of a green roof system is shown. The exemplary method 400 includes: providing a plurality of plastic fibers, at 402; forming a non-woven blanket from the plastic fibers, at 404; cutting the non-woven blanket to a desired size, at 406; and forming the non-woven blanket into a tray, at 408. During the forming of the tray, the non-woven blanket may be heated to cause at least a portion of the plastic fibers to form connections through melting.

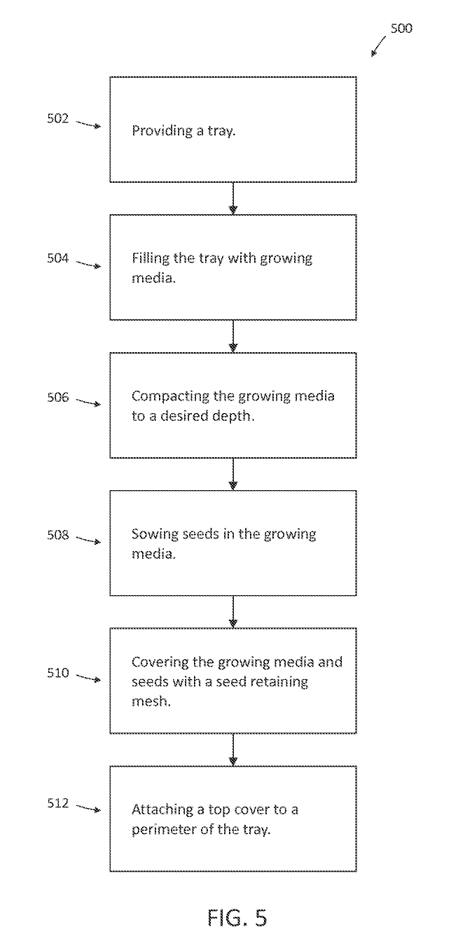

Referring now to FIG. 5, a flow chart of an exemplary method 500 of assembling a modular green roof module is shown. The exemplary method 500 includes: providing a tray, at 502; filling the tray with growing media, at 504; compacting the growing media to a desired depth, at 506; sowing seeds in the growing media, at 508; covering the growing media and seeds with a seed retaining layer, at 510; and attaching a top cover to a perimeter of the tray, at 512. The exemplary method 500 can be implemented with any of the exemplary trays 110, 210 described above, or another green roof system module tray. In some embodiments, the assembled module is packaged inside a cardboard box for shipment.

During the filling step, the empty tray 110, 210 is supported by a form holder on a flat surface. Growing media 124, 224 is deposited in the tray 110, 210 and is compressed lightly to form a uniform surface at the top edge of the tray 110, 210. The seed retaining layer 128, 228 is draped evenly over the tray 110, 210 and seeds 126, 226 are planted by overhead sowing at a designated sowing rate for the particular seed mixture. A cover 120, 220 formed of pre-cut netting of Nylon polymer is bonded with a hot melt application via hot melt gun on the lip 114, 214 of the tray 110, 210 with a single bead ⅛th-¼th thick.

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

While the present application has been illustrated by the description of embodiments thereof, and while the embodiments have been described in considerable detail, it is not the intention of the applicants to restrict or in any way limit the scope of the disclosure to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the disclosures may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts and features of the disclosures—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present application even if such embodiments are not expressly disclosed herein. Additionally, even though some features, concepts or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated. Moreover, while various aspects, features and concepts may be expressly identified herein as being inventive or forming part of an disclosure, such identification is not intended to be exclusive, but rather there may be inventive aspects, concepts and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

While the present application has been illustrated by the description of embodiments thereof, and while the embodiments have been described in considerable detail, it is not the intention of the applicants to restrict or in any way limit the scope of the disclosure to such details. Additional advantages and modifications will readily appear to those skilled in the art. For example, the steps of all processes and methods herein can be performed in any order, unless two or more steps are expressly stated as being performed in a particular order, or certain steps inherently require a particular order. Accordingly, departures may be made from such details without departing from the spirit or scope of the applicant's general inventive concept

1. A module for a green roof system comprising:
a tray thermoformed from a blanket of non-woven polyethylene terephthalate plastic fibers, the tray comprising:
a bottom surface;
a sidewall extending upward from the bottom surface to a lip; and
one or more raised portions separating the bottom surface into a plurality of cells;
wherein the one or more raised portions form water drainage channels;
growing media comprising at least one of expanded shale, expanded clay, expanded slate, sand, wood fines, coir, compost, and biosolids;
a seed retaining mesh formed of the polyethylene terephthalate plastic fibers;
a plurality of seeds; and
a top cover formed of the polyethylene terephthalate plastic fibers, the top cover being attached to the lip of the tray;
wherein the polyethylene terephthalate plastic fibers used to make the tray, seed retaining mesh, and top cover are sourced entirely from recycled material;
wherein the tray is porous, allowing water to pass through at least a portion of the bottom surface while prohibiting passage of particles having an average diameter between about 0.02 mm to about 9.5 mm through the bottom surface.

2. The module according to claim 1, wherein the drainage channels are formed below the bottom surface of the tray.

3. The module according to claim 1, wherein at least one of the seeds and growing media is selected based on the climate of a geographic region where the module is installed.

4. The module according to claim 1, wherein the polyethylene terephthalate plastic fibers comprise fibers of at least three different sizes.

5. The module according to claim 4, wherein the first fiber size is about 2.5 to 4 denier, the second fiber size is about 5 to 8 denier, and the third fiber size is about 9 to 13 denier.

6. The module according to claim 4, wherein the first fiber size is about 2.5 denier, the second fiber size is about 6 denier, and the third fiber size is about 9 denier.

7. The module according to claim 5, wherein one third of the volume of the polyethylene terephthalate plastic fibers are a first fiber size, one third are a second fiber size, and one third are a third fiber size.

8. The module according to claim 1, wherein the gaps between the polyethylene terephthalate plastic fibers of the tray are about 0.01 mm to about 0.04 mm.

9. A tray for a module of a green roof system comprising:
a bottom surface;
a sidewall extending upward from the perimeter of the bottom surface to a lip; and
one or more raised portions of the bottom surface that divide the bottom surface into a plurality of cells;
wherein at least the bottom surface is porous and has a porosity of about 50 percent to about 80 percent; and
wherein the bottom surface prohibits the passage of particles larger than about 0.01 mm in diameter.

10. The tray according to claim 9, wherein at least the bottom surface of the tray is formed from a non-woven blanket of plastic fibers.

11. The tray according to claim 10, wherein the plastic fibers are polyethylene terephthalate plastic fibers.

12. The tray according to claim 11, wherein the polyethylene terephthalate plastic is post-consumer plastic.

13. The tray according to claim 10, wherein the plastic fibers comprise at least three different sizes of plastic fibers.

14. The tray according to claim 13, wherein the first fiber size is about 2.5 to 4 denier, the second fiber size is about 5 to 8 denier, and the third fiber size is about 9 to 13 denier.

15. The tray according to claim 13, wherein the first fiber size is about 2.5 denier, the second fiber size is about 6 denier, and the third fiber size is about 9 denier.

16. The tray according to claim 14, wherein one third of the volume of the plastic fibers are a first fiber size, one third are a second fiber size, and one third are a third fiber size.

17. The tray according to claim 9, wherein the bottom surface prohibits passage of particles having an average diameter between about 0.02 mm to about 9.5 mm through the bottom surface.

18. A method of making a tray for a module of a green roof system, the method comprising:
providing a plurality of plastic fibers;
forming a non-woven blanket from the plastic fibers;
cutting the non-woven blanket to a desired size; and
forming the non-woven blanket into a tray having:
a bottom surface;
a sidewall extending upward from the perimeter of the bottom surface to a lip; and
one or more raised portions of the bottom surface that divide the bottom surface into a plurality of cells.

19. The method of claim 18, wherein forming the non-woven blanket into a tray involves heating the non-woven blanket to cause at least a portion of the plastic fibers to form connections through melting.

20. The method of claim 18, wherein the plastic fibers are polyethylene terephthalate plastic fibers.

21. The method of claim 18, wherein the plastic fibers comprise at least three different size plastic fibers.

22. The method of claim 18, wherein a first fiber size is about 2.5 to 4 denier, a second fiber size is about 5 to 8 denier, and a third fiber size is about 9 to 13 denier.

23. The method of claim 18, wherein a first fiber size is about 2.5 denier, a second fiber size is about 6 denier, and a third fiber size is about 9 denier.

24. A green roof system comprising:
a plurality of modules of claim 1;
wherein the plurality of modules are arranged on a roof top; and
wherein water drainage channels are formed between the tray and rooftop.

25. A module for a green roof system comprising:
a tray thermoformed from a blanket of non-woven polyethylene terephthalate plastic fibers, the tray comprising:
a bottom surface;
a sidewall extending upward from the bottom surface to a lip; and
one or more raised portions separating the bottom surface into a plurality of cells;
wherein the one or more raised portions form water drainage channels;
growing media comprising at least one of expanded shale, expanded clay, expanded slate, sand, wood fines, coir, compost, and biosolids;
a seed retaining mesh; and
a plurality of seeds;
wherein the tray is porous, allowing water to pass through at least a portion of the bottom surface while prohibiting passage of particles having an average diameter between about 0.02 mm to about 9.5 mm through the bottom surface.

26. The module according to claim 25, wherein the gaps between the polyethylene terephthalate plastic fibers of the tray are about 0.01 mm to about 0.04 mm.
